(19) United States
(12) Patent Application Publication
(10) Pub. No.: US 2005/0000740 A1
(43) Pub. Date: Jan. 6, 2005

(54) Moveable male hog cage

(76) Inventors: Roger Tessier, Lefebvre (CA); Martin Tessier, Lefebvre (CA)

Correspondence Address: OGILVY RENAULT, 1981 MCGILL COLLEGE AVENUE, SUITE 1600, MONTREAL, QC, H3A2Y3, CA

(21) Appl. No.: 10/898,327

(22) Filed: Jul. 26, 2004

Related U.S. Application Data
(63) Continuation of application No. 10/141,765, filed on May 10, 2002, now abandoned.
(60) Provisional application No. 60/289,820, filed on May 10, 2001.

(51) Int. Cl. B60K 1/00

(52) U.S. Cl. 180/65.1

(57) ABSTRACT

A moveable cart suitable for use on a hog farm, comprises a base, which has wheels mounted thereon, a see-through wall extending upwardly from the base at a location suitable for abutting engagement by the male hog head standing on the base, a mechanism associated with the see-through wall for forcibly biasing the male hog head on one lateral side direction of the cart, and at least one opening in the wall sized to permit a snout of a hog to at least partially extend therethrough. The cart can also take the form of a male hog cage having two sides, a front end and a rear end, and comprising a base for supporting a male hog having its head destined to be located at the front end of the cage, a peripheral wall upstanding from the base for preventing the male hog from leaving the cage, and a head positioning device for positioning the head of the male hog towards a selected one of the two sides.

### BACKGROUND OF THE INVENTION

1. Field of the Invention

The present invention relates to a moveable cart for use in transporting a male hog past rows of stationary sows, permitting snout to snout contact between the sows and the male hog. Such a “beauty contest”, by generating sexual arousal of the sows, increases the success rate during artificial insemination.

2. Description of the Prior Art

U.S. Pat. No. 5,467,734 issued Nov. 21, 1995 to the Chinese Ying Kuon HO, discloses a moveable cart into which a pet can be kept by its keeper so as to be able to carry same in a safe fashion when going out.

The present invention is an improvement over Canadian patent application No. 2,270,319 published Aug. 22, 1999 in the name of Robert Labrecque et al. In this patent application, the moveable cart comprises a base having wheel mounted thereon, one or more walls extending upwardly from the base, a panel made from an opaque material and attached to at least one of these upright walls for blocking visual access in at least one direction between the interior and exterior of the cart, and one or more openings in this upright wall(s) sized to permit a snout of a male hog to at least: partially extend therethrough. This way, the male hog attention is focused toward the nearby row of sows.

The wheel motor drive is below the base, thus undesirably creating a lump in the cubicle, for the male hog.

### SUMMARY OF THE INVENTION

It is therefore an aim of the present invention to provide a moveable cart suitable for use on a hog farm and having a mechanism for forcibly biasing the male hog head towards one lateral side of the cart.

It is also an aim of the present invention to provide a male hog cage having a head positioning device for positioning the head of the male hog towards a selected one of at least one of the two sides of the cage.

Therefore, in accordance with the present invention, there is provided a moveable cart suitable for use on a hog farm, the moveable cart comprising a base, said base having wheels mounted thereon; a see-through wall extending upwardly from said base at a location suitable for abutting engagement by the male hog head standing on said base; means associated with said at least one see-through wall for forcibly biasing the male hog head on one lateral side direction of the cart; and at least one opening in said at least one wall sized to permit a snout of a hog to at least partially extend therethrough.

Also in accordance with the present invention, there is provided a male hog cage having two sides, a front end and a rear end comprising:
a base, for supporting a male hog, with the male hog head being destined to be located at the front end of said cage;
a peripheral wall upstanding from said base, for preventing the male hog from leaving said cage; and
a male hog head positioning device, for positioning the head of the male hog towards a selected one of said two sides.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is an isometric exploded view of the wheel base of the moveable cart according to the present invention;

FIG. 2 is an isometric view of the cubicle that is to fit over the wheel base shown in FIG. 1 for receiving the male hog therein;

FIG. 3 is a schematic top plan view of a pair of male hog carrying moveable carts moving along two rows of sows;

FIG. 4 is a top plan view of the male hog carrying moveable cart, moving about a narrow corner section of the sow farm;

FIG. 5A is a perspective view of the male hog head diverting panel system of the invention;

FIG. 5B is a top plan view of the panel system of FIG. 5A;

FIG. 5C is a plan view of the pivotable panel from the panel system of FIG. 5A;

FIG. 6 is a perspective view of a second embodiment of the male hog cage according to the present invention;

FIG. 7 is a bottom plan view of the cage of FIG. 6;

FIG. 8 is a top plan view of the cage of FIG. 6;

FIG. 9 is an enlarged perspective view of the front section of the cage of FIG. 6, with one door panel being removed to show the male hog head positioning panel located inside the cage front section;

FIG. 10 is a schematic top plan view of the front portion of the cage of FIG. 6, suggesting in dotted lines the different positions of the inner head positioning panel;

FIG. 11 is a schematic top plan view of the front portion of the cage of FIG. 6, suggesting different positions taken by the spring-loaded front doors;

FIG. 12 is a schematic top plan view of the cage of FIG. 6, showing how it may be aligned with the static sow cages;

FIG. 13 is a schematic top plan view of the cage of FIG. 6, showing how it may be moved around a corner in a corridor, and further suggesting in dotted lines how a hypothetical correspondingly sized rectangular cage would not be movable through a similar corner; and

FIG. 14 is a top plan view of a third embodiment of a male hog cage according to the present invention.

### DESCRIPTION OF THE PREFERRED EMBODIMENTS

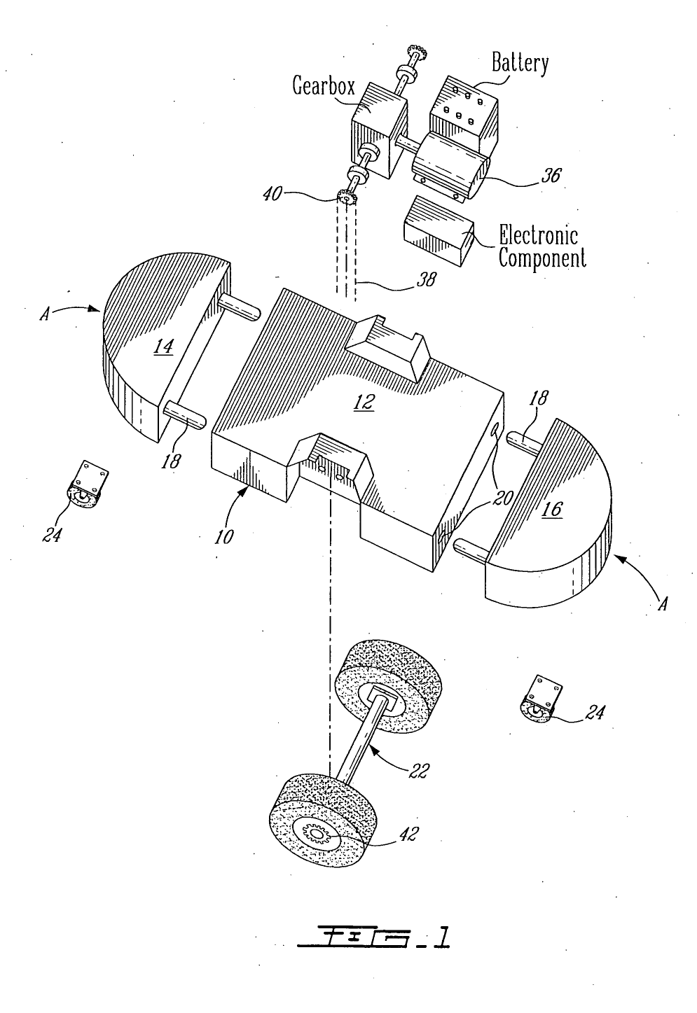

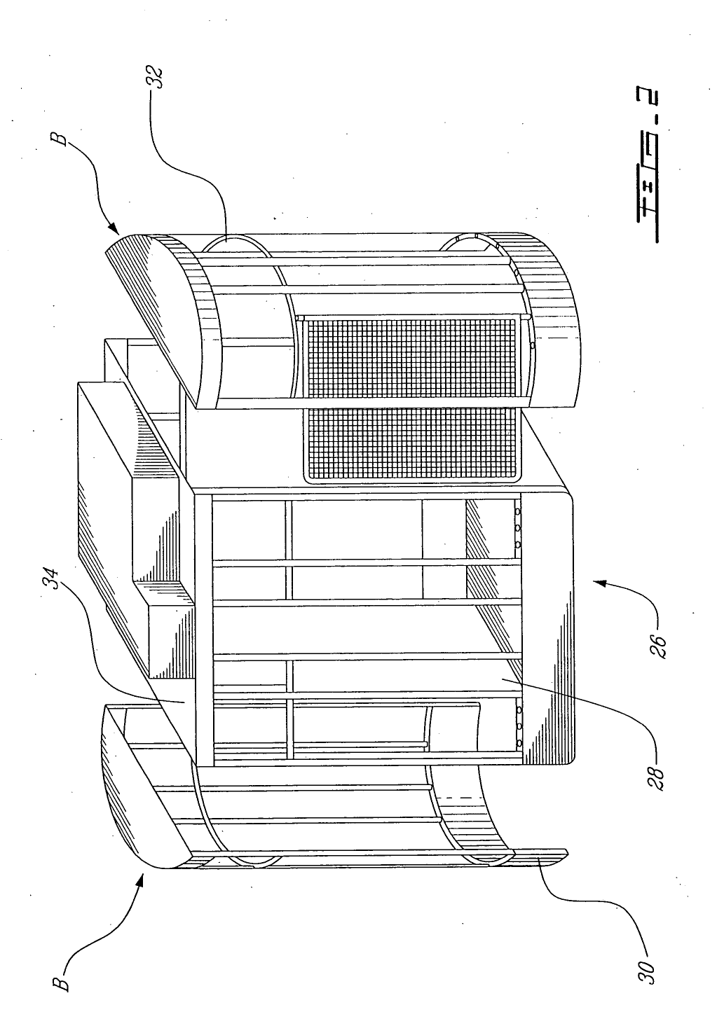

As shown in FIGS. 1 and 2, the base 10 of moveable cart 11 includes a main rectangular panel 12 with a pair of semi-circular (or polygonal) panels 14, 16, fitted at opposite ends thereof by securing pins 18 projecting from the end panels 14, 16, and releasably frictionally engaging complementary bores 20 made into the rectangular panel 12. A single axle 22 having a pair of opposite wheels fits beneath the central portion of main panel 12, while a small swivel caster 24 is mounted under each end panel 14, 16. A cubicle 26 is mounted over base 10 and is made from generally open lateral flat side walls 28, arcuate generally open front and rear walls 30, 32, and a ceiling 34. A motor drive engine 36 is mounted over and supported by ceiling 34. An endless chain 38 interconnects a drive sprocket 40 of top motor engine 36 to a wheel sprocket 42 of bottom wheel axle 22, for autonomous drive of the cart 11 over the ground.

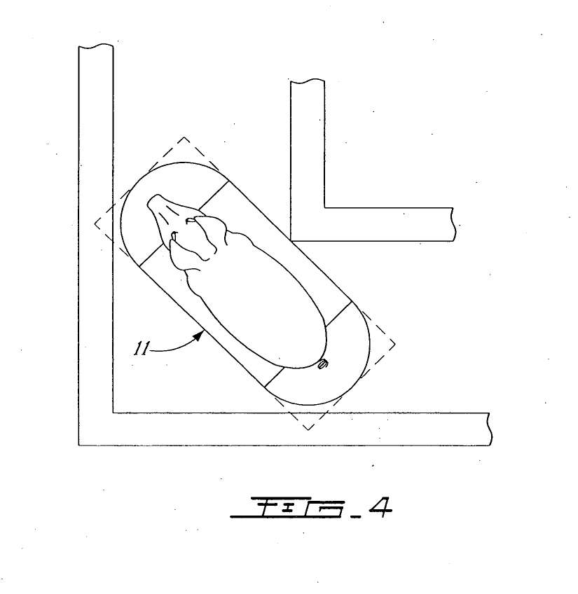

As suggested in FIG. 4, the rounded or polygonal smooth shape of the front and rear arcuate upright walls 30, 32, and front and rear end base panels 14, 16, enables easier displacement of the moveable cart 11 with the male hog H thereon, around tight corners in between two rows of sows S.

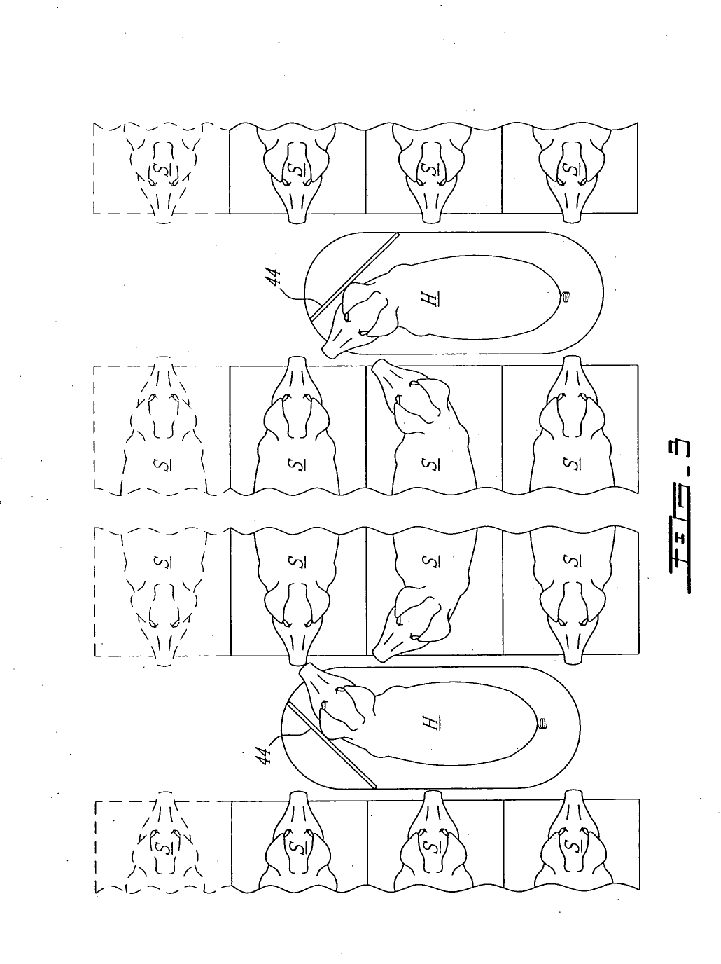

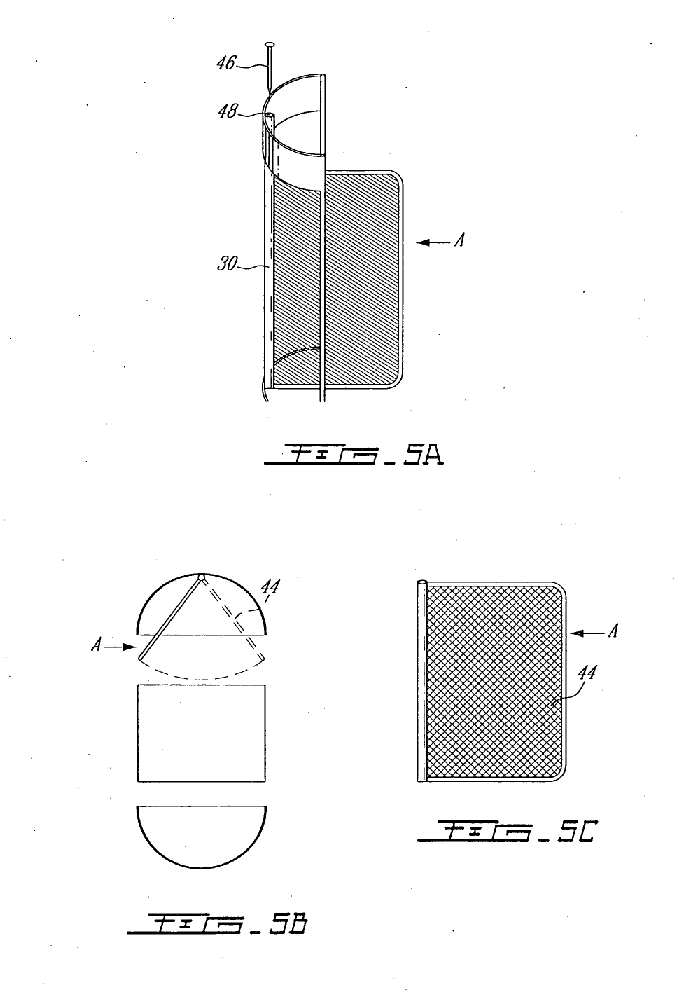

As shown in FIGS. 3 and 5A-5C, and according to an important feature of the invention, there is provided inside cubicle 26 adjacent the front end thereof 30, an inclined perforated panel 44 made preferably from metallic wire netting or other see-through strong material capable of retaining the hog. Panel 44 is pivotally carried by a front upright pivot rod 46 which is pivotally carried into brackets 48 integral to the inner face of an intermediate section of front arcuate upright wall 30. This pivotable panel 44 is pivotable between a first limit position, shown in full lines in FIG. 51B, and a second limit position, shown in dotted lines in FIG. 5B, these two panel limit positions being spread apart by about a quarter of a turn (i.e. about 90°). In each of these two limit positions, the pivotable panel 44 defines an acute angle, preferably about 45 degrees, relative to a vertical plane intersecting the longitudinal fore and aft axis of the cart 11.

In use, the wire panel 44 is inclined in its first leftwardly forwardly inclined limit position shown at the right hand side of FIG. 3, when the row of sows is located on the left of the cart; and alternately, when the row of sows is located on the right of the cart as shown on the left hand side of FIG. 3, the wire panel 44 is inclined in its second rightwardly forwardly inclined limit position. Since the front arcuate upright wall 30 is generally open, the head of male hog H is forced in oblique direction by abutting against the inclined panel 44, while still being able to freely extend its snout through the open wall 30 to come in contact with the sows snouts of the adjacent row.

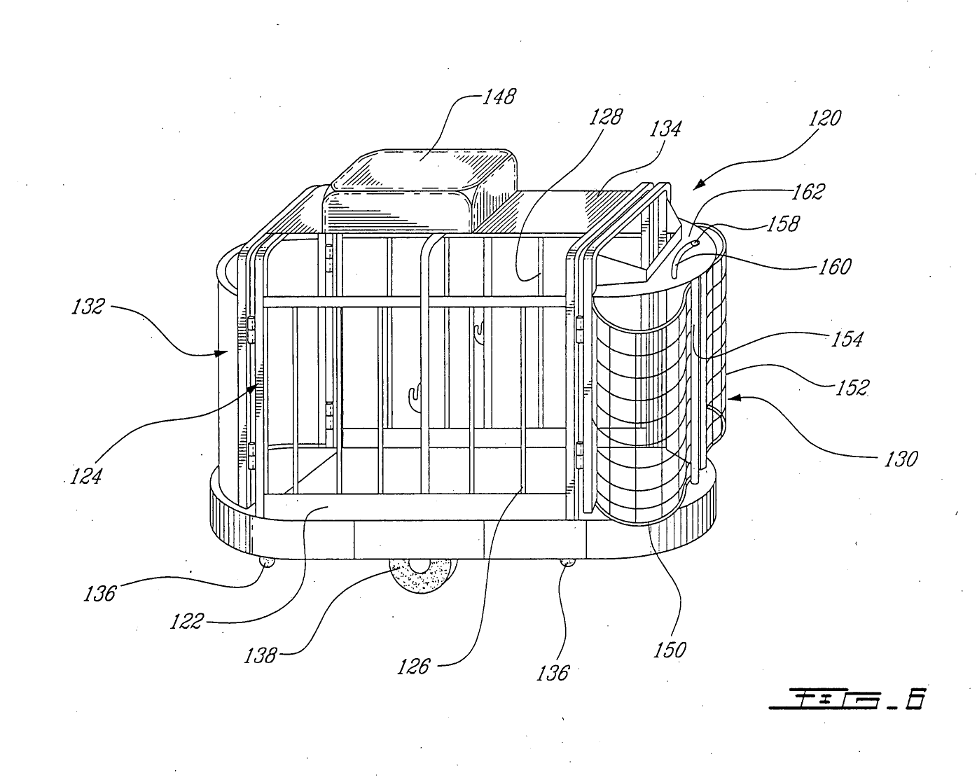

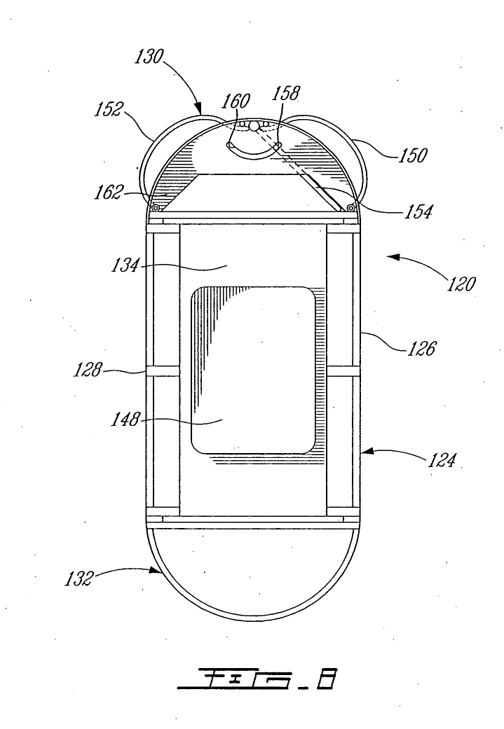

FIGS. 6 to 8 show a movable male hog cage 120 according to the present invention. Cage 120 has a flat rigid flooring 122 having a generally ovoid shape, with rounded front and rear sections. A peripheral wall 124 stands in an upright position from flooring 122, wall 124 having a pair of straight lateral sections 126, 128 made from metallic bars, a front section 130 and a rear section 132. Lateral sections 126, 128 are linked to a top ceiling panel 134. The wall rear section 132 is made of a pair of full pivotable door panels, which can be opened and closed to let a male hog into or out of cage 120. A latch (not shown) prevents the doors from accidentally opening. The fact that the rear doors are made of full panels prevents hog excrements from being ejected out of the cage, which could contaminate the sow food lying on the ground.

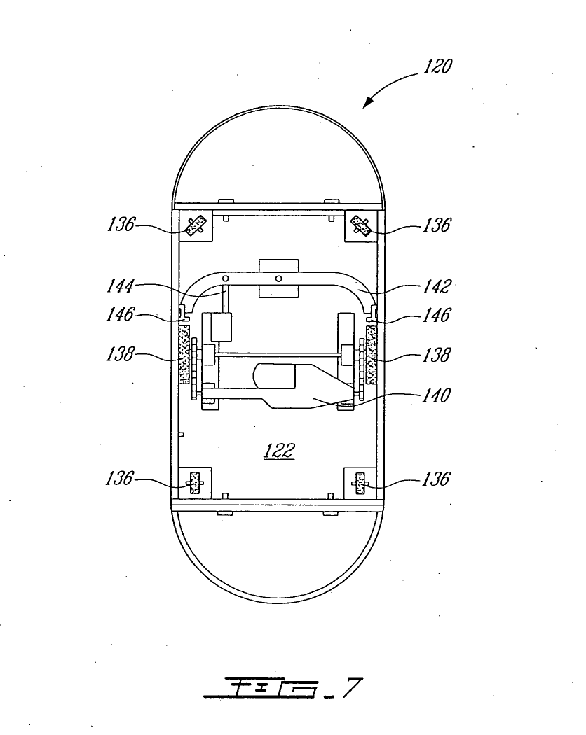

As shown in FIG. 7, cage 120 is supported on a set of six wheels, namely four idle wheels 136 and a pair of drive wheels 38 independently controlled by a motor 140. An arcuate pivotable brake arm 142 is pivotally mounted to base 122, the position of brake arm 142 being controlled by a hydraulic ram 144 which may pivot brake arm 142 so that either one or none or the two brake pads 146 provided at the opposite extremities of brake arm 142 engage the corresponding wheels 138. That is to say, the braking mechanism of the present invention may be in an inoperative condition, in which none of the brake pads 146 engage the wheels 138, or alternatively the braking mechanism may be in an operative condition, in which it is pivoted towards a selected wheel 138 which will be engaged by a corresponding brake pad 146, to allow cage 120 to be steered around tight corners by thus blocking a single one of the two wheels 138.

A control panel 148 is fixedly installed on top of ceiling 134. Control panel 148 may commands motor 140 and hydraulic ram 144. Preferably, control panel 148 may be remotely controlled, for example by means of a remote control device (not shown).

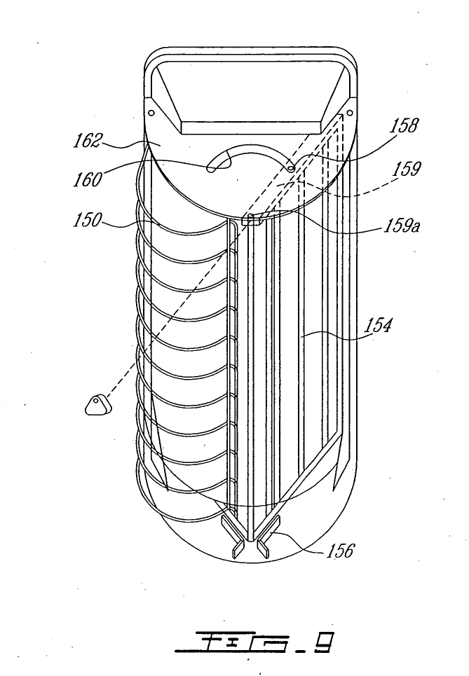

The front section 130 of cage 120, shown more particularly in FIGS. 6, 8 and 9, includes a pair of front pivotable doors 150, 152 made of a wire meshing that has openings therein which are preferably smaller than a male hog snout, to prevent the male hog from biting a person standing in close proximity to the front end of the cage 120. Alternately, doors 150, 152 could be made from bars in a similar manner than side walls 126, 128. Doors 150, 152 can be opened and closed to allow entrance or egress of the male hog from the cage. A latch (not shown) is provided to prevent doors 150, 152 from being accidentally opened.

It can be seen that doors 150, 152 bulge outwardly at their central portion. This is desirable, as it will allow the male hog to get his head closer to the heads of the sows when the male hog is in the cage.

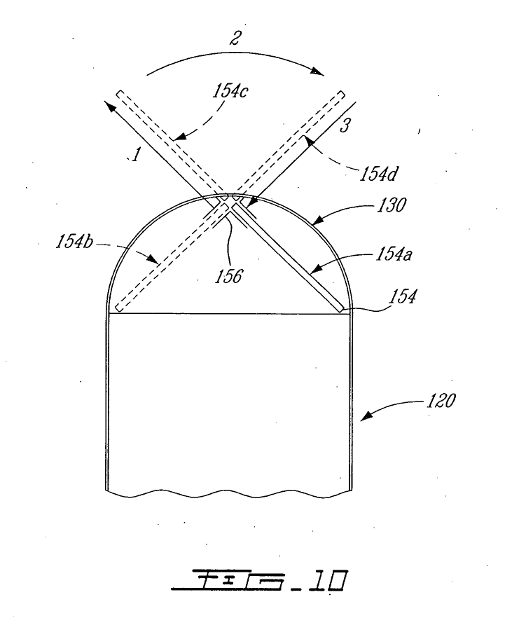

FIGS. 6, 8, 9 and 10 show that a head positioning panel 154 is provided inside cage 120, at the front section 130 thereof. Panel 154 is oriented in one of two positions 154a, 154b shown in FIG. 10, with position 154a being shown in full lines, while position 154b is shown in dotted lines. Panel 154 is made of spaced vertical bars extending inside a rectangular frame, although it could be made of a wire meshing such as the one seen on doors 150, 152. Panel 154 engages a V-shaped guide track 156 that has three open ends. Guide track 156 prevents panel 154 from pivoting away from either one of its inner positions 154a, 154b when panel 154 is located within cage front section 130. The panel top run slidably engages a pivotable track 159 that is pivotally connected at its first end 159a to a top plate 162 forming a front extension of ceiling 134. A top pin 158 fixed to pivotable track 159 engages an arcuate slot 160 defined in top plate 162, to allow pivotable track 159 to pivot between the corresponding panel positions 154a, 154b.

Panel 154 may thus close off a portion of the cage front section 130, by being positioned in a selected one of the two positions 154a, 154b. To change the position of panel 154, as suggested in FIG. 10, the following steps are followed from the initial position 154a:
a) panel 154 is outwardly slid through the opened guide track 156, through pivotable track 159 and between doors 150, 152 out of the cage front section 130, from position 154a to position 154c;
b) panel 154 is pivoted to position 154d, with pivotable track 159 being forced to pivot also since panel 154 still partly engages pivotable track 159; pivotable track 159 is consequently pivoted through its engagement with panel 154, from a position corresponding to the panel position 154a to a position corresponding to panel position 154b; and
c) panel 154 is slid back to position 154b between doors 150, 152, through guide track 156 and through pivotable track 159.

Panel 154 may be moved back to position 154a by accomplishing the above steps, although in inverted directions and order.

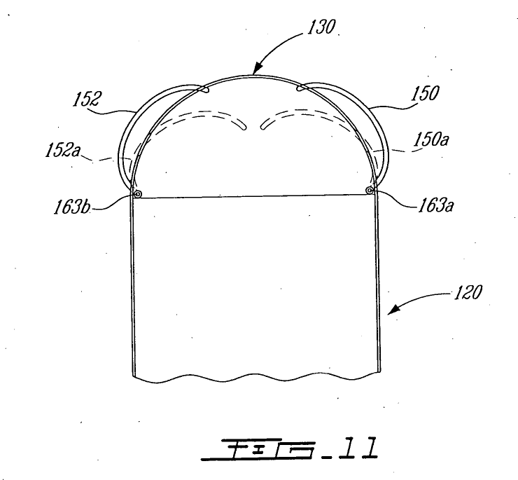

FIG. 11 shows that the front doors 150, 152 are installed on a spring-loaded pivotable mount, so as to be able to pivot inwardly of cage 120 towards inner limit positions 150a, 152a. Thus, cage 120 is more easily maneuverable around tight corners, while still allowing the male hog to move his head closer to the sow's heads when necessary. Indeed, while the doors are continuously forced towards their outer limit positions 150, 152, they may be forced inwardly against the bias of their springs 163a, 163b if they come into contact with outer elements, such as walls.

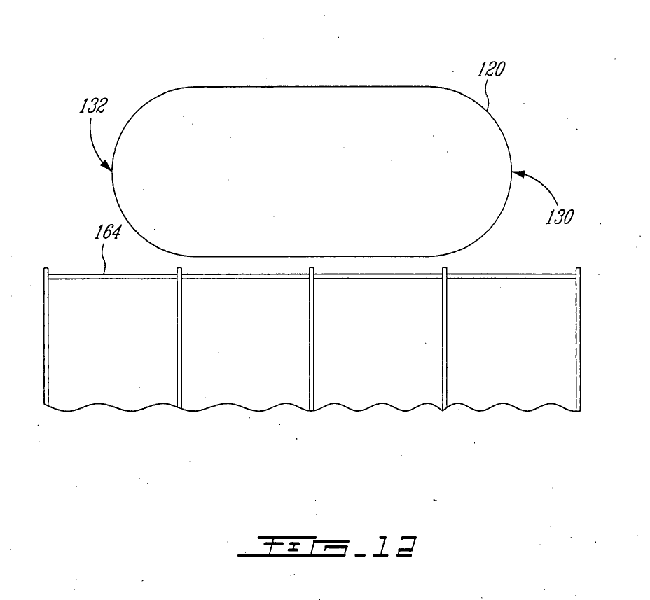

FIG. 12 shows how the cage 120 is to be aligned with the static sow cages 164.

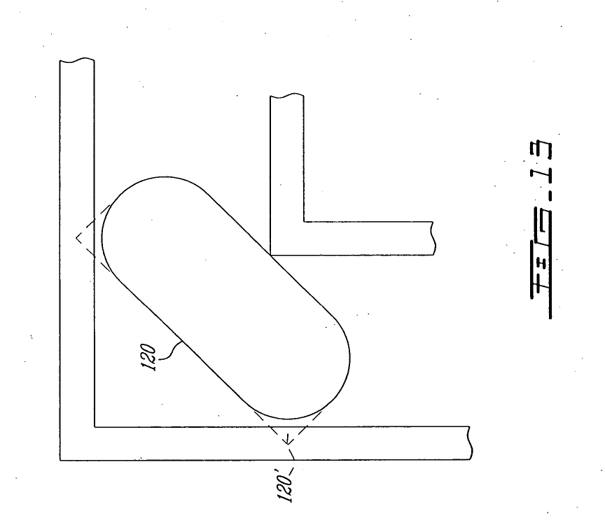

FIG. 13 shows that cage 120 may be moved around corners. Indeed, the rounded or ovoid configuration of cage 120 allows for an enhanced maneuverability of cage 120, which would not be the case if the cage had a correspondingly sized rectangular configuration 120.

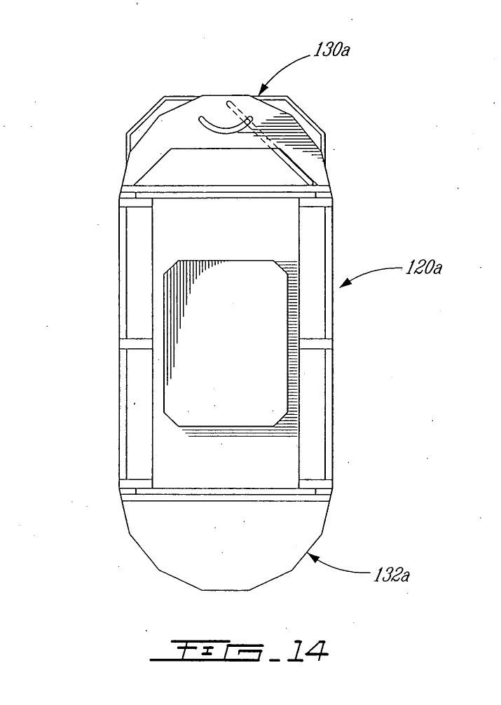

FIG. 14 shows an alternate embodiment of a cage 120a, wherein it can be seen that the front and rear sections 130a, 132a thereof have a polygonal, although still generally rounded, configuration.

In use, a male hog is to be inserted into the cage 120, the latter then being circulated near the sow cages 164, to facilitate artificial insemination of the sows, as known in the art. The pivotable panel 154 provided in the cage 120 of the present invention forces the male hog to orient his head towards one of the two sides of the cage 120. Thus, for example, if the sow cages 164 are located on the right hand side of the male hog cage, then panel 154 will be positioned on the left-hand side of the front cage section 130, so that the male hog head will be forced to remain on the right-hand side of the cage. Consequently, the male hog head will be positioned and oriented adjacent the sow heads, which is desirable to facilitate sow artificial insemination.

According to the present invention, any physical means of forcing the male hog to orient his head towards one side of the cage or the other, is also considered to be included within the scope of the present invention. For example, chains may be used to pull on the male hog head, or other devices may be used either to apply pressure on the male hog head, or to obstruct one part of the front section 130 of the cage 120, to force the male hog to orient his head on the other side.

1. A moveable cart suitable for use on a hog farm, the moveable cart comprising a base, said base having wheels mounted thereon; a see-through wall extending upwardly from said base at a location suitable for abutting engagement by the male hog head standing on said base; means associated with said at least one see-through wall for forcibly biasing the male hog head on one lateral side direction of the cart; and at least one opening in said see-through wall sized to permit a snout of a hog to at least partially extend therethrough.

2. A male hog cage having two sides, a front end and a rear end comprising:
a base, for supporting a male hog, with the male hog head being destined to be located at the front end of said cage;
a peripheral wall upstanding from said base, for preventing the male hog from leaving said cage; and
a male hog head positioning device, for forcibly biasing and positioning the head of the male hog towards a selected one of said two sides.
